(19) United States
(12) Patent Application Publication
(10) Pub. No.: US 2026/0307261 A1
(43) Pub. Date: Oct. 8, 2026

(54) REAL-TIME MOTION SYNCHRONIZATION CONTROL METHOD BASED ON MULTI-AXIS EXPANSION OF COLLABORATIVE ROBOT

(71) Applicant: BRILS Co., Ltd., Incheon (KR)

(72) Inventor: Jin JEON, Incheon (KR)

(21) Appl. No.: 19/638,195

(22) Filed: Apr. 3, 2026

(30) Foreign Application Priority Data
Apr. 4, 2025 (KR) 10-2025-0044166

(51) Int. Cl. B25J 9/16

(52) U.S. Cl. CPC B25J 9/1692

(57) ABSTRACT

An embodiment relates to a real-time motion synchronization control method based on multi-axis expansion of a collaborative robot. More specifically, there is provided a real-time motion synchronization control method based on multi-axis expansion of a collaborative robot, performed by a collaborative robot system, in which the collaborative robot system includes a collaborative robot including a plurality of joint portions, an additional axis device coupled to the collaborative robot and providing a plurality of axes corresponding to the plurality of joint portions and an additional axis, and a control unit, the method comprising controlling, by the control unit, each axis such that the plurality of axes and the additional axis are synchronized in real time.

### CROSS REFERENCE TO RELATED APPLICATION

The present application claims priority to Korean Patent Application No. 10-2025-0044166, filed Apr. 4, 2025, the entire contents of which are incorporated here for all purposes by this reference.

### TECHNICAL FIELD

The present disclosure relates to a real-time motion synchronization control method based on multi-axis expansion of a collaborative robot. More particularly, the present disclosure relates to a method for performing precise synchronized control by expanding a conventional 6-axis robot to up to 10 axes, including an additional axis such as a lift, a rail, and a positioner, using an integrated controller and a pendant.

### BACKGROUND

In a conventional technology, a 6-axis robot is mainly used, and thus it is limited to integrate an additional axis such as a lift, a rail, and a positioner to perform a complex process, and accordingly, precision and stability of the process may be degraded. In addition, when a separate control system is introduced for multi-axis control, system configuration and operating costs increase, and synchronization between axes becomes difficult, thereby reducing reliability of an entire process. As described above, a conventional collaborative robot system is not suitable for performing a high-level process requiring multi-axis expansion, and thus has a problem in that it is difficult to secure cost efficiency and process stability.

To address these issues, there is an increasing need for a technology capable of expanding up to 10 axes, including an additional axis such as a lift, a rail, and a positioner, in addition to a conventional 6-axis robot, and performing fully synchronized and integrated control of all axes using a single pendant.

### PRIOR ART DOCUMENT

### Patent Document

Patent Document: Korean Patent No. 10-2784903.

### SUMMARY

An object of the present disclosure is to provide a real-time motion synchronization control unit and method based on multi-axis expansion, which are capable of overcoming a high-cost problem of a servo motor and a reducer, which are core components of a conventional collaborative robot, and limitations of multi-axis expansion and precise synchronization of a 6-axis robot system.

Another object of the present disclosure is to provide a device and method capable of expanding a 6-axis collaborative robot to up to 10 axes by adding an additional axis such as a lift, a rail, and a positioner, and enabling all axes to be synchronized in real time through integrated control using a single pendant.

Another object of the present disclosure is to provide a device and method capable of minimizing an error that may occur during a complex process and improving system stability by precisely setting and correcting control parameters including position, rotation angle, movement distance, torque, speed, acceleration, and deceleration of each axis by a control unit.

Another object of the present disclosure is to provide a device and method capable of implementing precise synchronization control even in a high-speed motion and a complex palletizing process by applying a PID control and a synchronization error correction algorithm to maintain an error between a target position and an actual position of an additional axis within 0.1 mm.

Another object of the present disclosure is to provide a collaborative robot system based on multi-axis expansion, which enables efficient and stable process execution through real-time communication and control between a joint portion of the collaborative robot and an additional axis so that a plurality of axes cooperatively operate.

Objects of the present disclosure are not limited to those described above, and other objects not described herein will be clearly understood by those skilled in the art from the following description.

In order to achieve the above-described objects, according to the present disclosure, there is provided a real-time motion synchronization control method based on multi-axis expansion of a collaborative robot, performed by a collaborative robot system, in which the collaborative robot system includes a collaborative robot including a plurality of joint portions, an additional axis device coupled to the collaborative robot and providing a plurality of axes corresponding to the plurality of joint portions and an additional axis, and a control unit, the method including: controlling, by the control unit, each axis such that the plurality of axes and the additional axis are synchronized in real time.

Moreover, the method may further include: by the control unit, setting a work path of the collaborative robot; setting control parameters of the plurality of joint portions and the additional axis device such that the plurality of joint portions and the additional axis device are synchronized in real time; and transmitting a control command based on the control parameters to the collaborative robot and the additional axis device.

In addition, the control parameters may include at least one of a position, a rotation angle, a movement distance, a torque, a speed, an acceleration, and a deceleration.

Moreover, the method may further include: by the control unit, setting a target position of the additional axis according to Equation 1.

$$Qad ( t ) = a ( \frac{1}{6} {\sum }_{i = 1}^{6} {Q}_{i} ( t ) ) + b \qquad [ Equation 1 ]$$

Here, Qad(t) is the target position of the additional axis, Qi(t) is an actual position of 6 axes of a collaborative robot, a is a scaling constant for an average operation of a basic 6 axes, and b is a position compensation value (offset) of the additional axis.

Moreover, the method may further include: by the control unit, calculating a control input function U(t) of the additional axis according to Equation 2 based on a proportional integral derivative (PID) control method.

$$U ( t ) = KpE ( t ) + Ki {\int }_{0}^{t} E ( τ ) d τ + Kd \frac{dE ( t )}{dt} , E ( t ) = Qad ( t ) - Qa ( t ) \qquad [ Equation 2 ]$$

Here, E(t) is a control error, Qad(t) is the target position of the additional axis, Qa(t) is an actual position of the additional axis, Kp is a proportional constant, Ki is an integral constant, and Kd is a derivative constant.

In addition, the method may further include: by the control unit, adjusting a synchronization error value represented by Equation 3 to be within 0.1 mm such that the plurality of axes and the additional axis are synchronized in real time.

$$\vert Qa ( t ) - ( a ( \frac{1}{6} {\sum }_{i = 1}^{6} {Q}_{i} ( t ) ) + b ) \vert \qquad [ Equation 3 ]$$

Here, Qa(t) is the actual position of the additional axis, Qi(t) is the actual position of the 6 axes of the collaborative robot, a is the scaling constant for the average operation of the basic 6 axes, and b is the position compensation value (offset) of the additional axis.

Furthermore, the additional axis device may include a lift configured to vertically move the collaborative robot.

Moreover, the additional axis device may include a rail configured to horizontally move the collaborative robot.

In addition, the additional axis device may include a positioner configured to move a work object of the collaborative robot.

Moreover, according to the present disclosure, there is provided a real-time motion synchronization control system based on multi-axis expansion of a collaborative robot, including: a collaborative robot including a plurality of joint portions; an additional axis device coupled to the collaborative robot and providing a plurality of axes corresponding to the plurality of joint portions and an additional axis; and a control unit configured to control each axis such that the plurality of axes and the additional axis are synchronized in real time.

Moreover, a computer-readable recording medium storing a computer program for implementing the present disclosure may be further provided.

According to the above-described means for achieving the objects of the present disclosure, it is possible to resolve synchronization error and control delay problems occurring in a conventional 6-axis collaborative robot system, thereby providing an effect in which all axes are precisely synchronized with a real-time control cycle of less than 1 ms.

According to the above-described means for achieving the objects of the present disclosure, by integrating the additional axis (lift, rail, and positioner) into a conventional collaborative robot to enable expansion up to 10 axes, it is possible to implement multi-axis simultaneous control required for performing complex processes, thereby providing an effect of dramatically improving work efficiency and productivity.

According to the above-described means for achieving the objects of the present disclosure, by precisely setting and correcting control parameters (position, rotation angle, movement distance, torque, speed, acceleration, and deceleration) of multiple axes through an integrated control method using a single control unit and a pendant, it is possible to significantly reduce system construction cost and operating cost without introducing an additional control system.

According to the above-described means for achieving the objects of the present disclosure, by enabling intuitive performance of work path setting and control parameter input using the pendant, a user can easily perform complex process control, thereby providing an effect of greatly improving usability.

According to the above-described means for achieving the objects of the present disclosure, by applying the PID control and the synchronization error correction algorithm to maintain a position error between the additional axis and a robot body within 0.1 mm, and by rapidly detecting and correcting collision and overload situations during operation through real-time sensor feedback, it is possible to significantly enhance stability and reliability of the system.

Effects of the present disclosure are not limited to the above-mentioned effects, and other effects not mentioned will be clearly understood by those skilled in the art from the following description.

### BRIEF DESCRIPTION OF THE DRAWINGS

FIG. 1 is a flowchart illustrating a real-time motion synchronization control method based on multi-axis expansion of a collaborative robot according to one embodiment of the present disclosure.

FIG. 2 is a flowchart illustrating a synchronization method between a joint portion and an additional axis device according to one embodiment of the present disclosure.

FIG. 3 is a block diagram illustrating a detailed configuration of a real-time motion synchronization control system based on multi-axis expansion of the collaborative robot according to one embodiment of the present disclosure.

FIG. 4 is an exemplary diagram illustrating the collaborative robot according to one embodiment of the present disclosure.

FIG. 5 is an exemplary diagram illustrating a system according to one embodiment of the present disclosure.

### DETAILED DESCRIPTION

Throughout the present disclosure, the same reference numerals denote the same components. The present disclosure does not describe all elements of the embodiments, and general contents in the technical field to which the present disclosure pertains or overlapping contents among the embodiments are omitted. The terms “unit, module, member, and block” used in the specification may be implemented as software or hardware, and according to embodiments, a plurality of “units, modules, members, and blocks” may be implemented as one component, or one “unit, module, member, or block” may include a plurality of components.

Throughout the specification, when a portion is described as being “connected” to another portion, this includes not only a case where the portion is directly connected, but also a case where the portion is indirectly connected, and the indirect connection includes connection through a wireless communication network.

In addition, when a portion is described as “including” a certain component, this does not exclude other components unless specifically stated otherwise, and means that other components may be further included.

Throughout the specification, when a member is described as being positioned “on” another member, this includes not only a case where the member is in contact with another member, but also a case where another member exists between the two members.

Terms such as first and second are used to distinguish one component from another component, and the components are not limited by the above terms.

A singular expression includes a plural expression unless the context clearly indicates otherwise.

In each step, identification symbols are used for convenience of description, and the identification symbols do not describe an order of the steps, and the steps may be performed in an order different from the stated order unless the context clearly indicates a specific order.

Hereinafter, operation principles and embodiments of the present disclosure will be described with reference to the accompanying drawings.

In the present specification, a “device according to the present disclosure” includes all types of devices capable of performing arithmetic processing and providing a result to a user. For example, the device according to the present disclosure may include a computer, a server device, and a portable terminal, or may be any one of these forms.

Here, the computer may include, for example, a notebook, a desktop, a laptop, a tablet PC, and a slate PC equipped with a web browser WEB Browser.

The server device is a server that processes information by communicating with an external device, and may include an application server, a computing server, a database server, a file server, a game server, a mail server, a proxy server, and a web server.

The portable terminal is, for example, a wireless communication device that ensures portability and mobility, and may include all types of handheld-based wireless communication devices such as Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access(CDMA)-2000, W-Code Division Multiple Access (W-CDMA), Wireless Broadband (WiBro) Internet terminal, and a smart phone Smart Phone, and may also include wearable devices such as a watch, a ring, a bracelet, an anklet, a necklace, glasses, contact lenses, or a head-mounted-device (HMD).

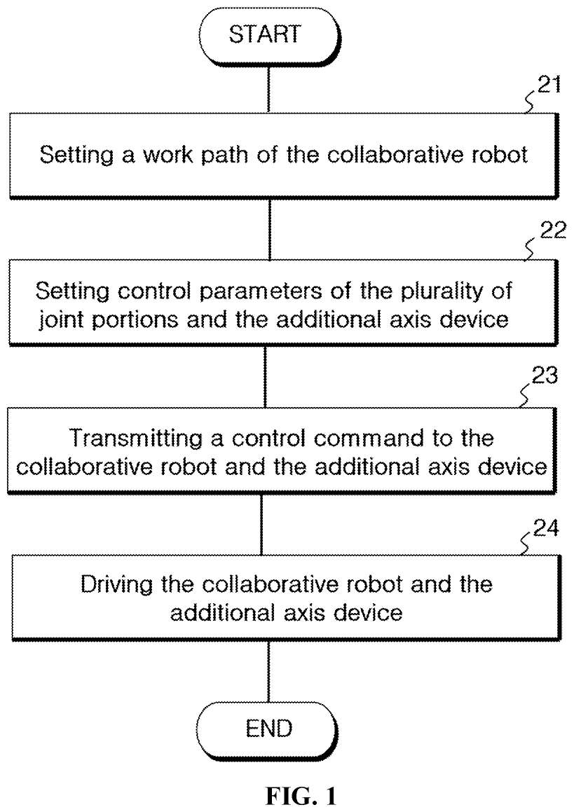

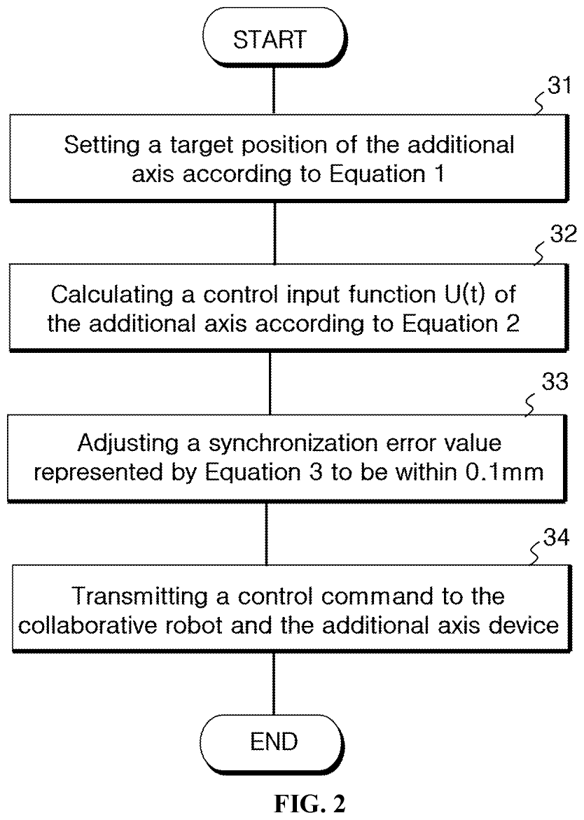

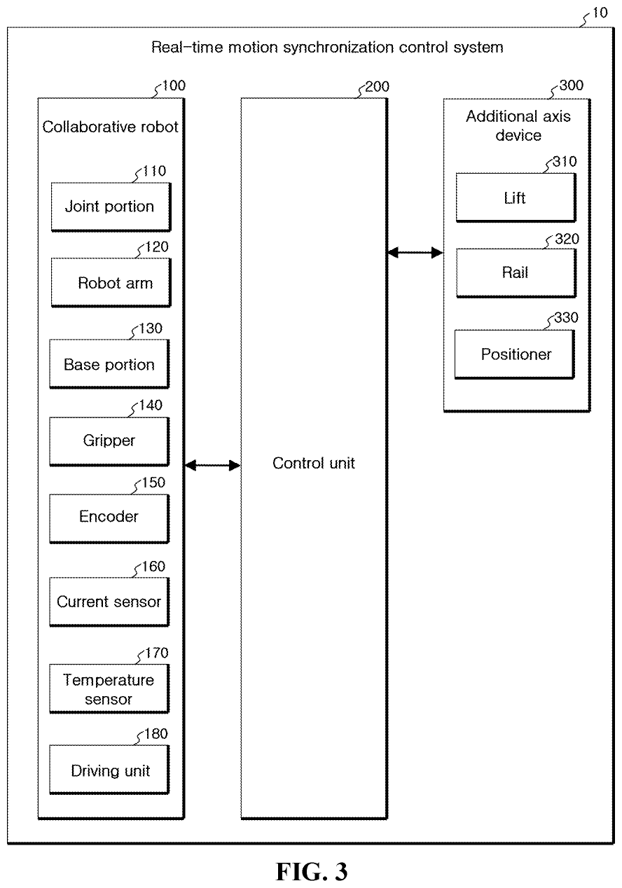

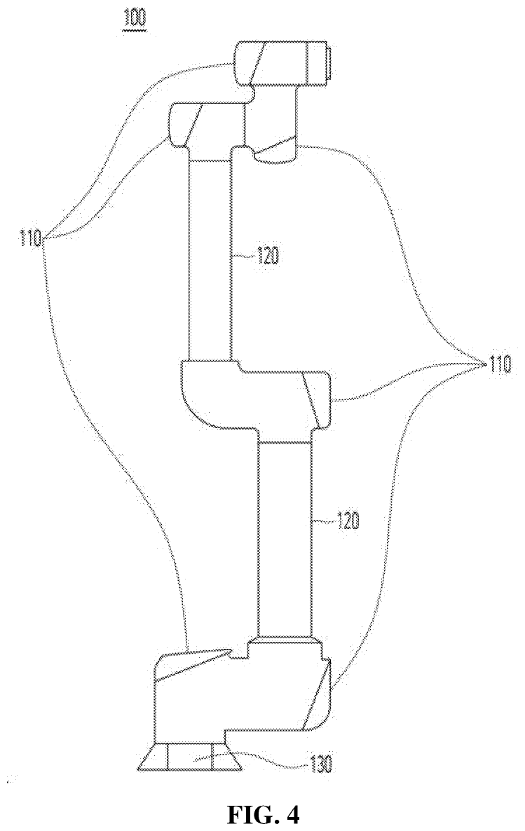

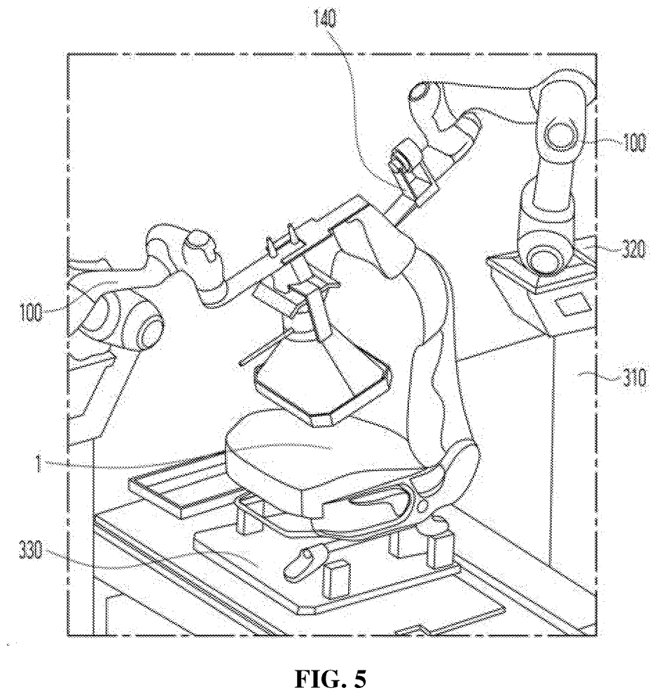

FIG. 1 is a flowchart illustrating a real-time motion synchronization control method based on multi-axis expansion of a collaborative robot according to one embodiment of the present disclosure. FIG. 2 is a flowchart illustrating a synchronization method between a joint portion and an additional axis device according to one embodiment of the present disclosure. FIG. 3 is a block diagram illustrating a detailed configuration of a real-time motion synchronization control system based on multi-axis expansion of the collaborative robot according to one embodiment of the present disclosure. FIG. 4 is an exemplary diagram illustrating a robot according to one embodiment of the present disclosure. FIG. 5 is an exemplary diagram illustrating a system according to one embodiment of the present disclosure.

Before describing main components of the present disclosure, representative operations of the present disclosure will be described first.

Referring to FIG. 1, in one embodiment, in operation 21, a control unit 200 may set a work path of a collaborative robot 100. For example, the control unit 200 may apply various algorithms and techniques for setting an entire work path that the collaborative robot 100 should perform. The control unit 200 may comprehensively analyze kinematic characteristics of a robot arm 120 and a gripper 140 based on position, rotation angle, and other kinematic information collected in real time from a plurality of joint portions 110 of the collaborative robot 100.

Based on such analysis results, the control unit 200 may calculate a path of a linear, curved, or combined form by considering obstacle information existing around a work object 1, constraint conditions of a work environment, and a collision risk that may occur when a robot moves. At this time, the control unit 200 may precisely calculate coordinate points that each joint portion 110 should reach, and determine optimal distribution of acceleration and deceleration for each section on the work path, thereby setting a path so that an error and a collision risk caused by inertia may be minimized even when the collaborative robot 100 moves at high speed. Such work path setting may be dynamically updated by the control unit 200 by combining pre-stored process data and real-time sensor feedback, thereby securing a stable work path even in a complex work environment.

In one embodiment, in operation 22, the control unit 200 may set control parameters of a plurality of joint portions 110 and an additional axis device 300 so that the plurality of joint portions 110 and the additional axis device 300 are synchronized in real time.

For example, in order to allow each axis of the collaborative robot 100 and the additional axis device 300 to be synchronized in real time, the control unit 200 may precisely calculate the control parameters to be applied to each axis. In this case, the control parameters may include various elements such as position, rotation angle, movement distance, torque, speed, acceleration, and deceleration, and may be individually or collectively set according to characteristics of each axis and a work environment. The control unit 200 may calculate an error between a current state and a target state of each joint portion 110 and the additional axis 300 by using real-time feedback information received from a position sensor such as an encoder 150 and environmental sensors such as a current sensor 160 and a temperature sensor 170.

Based on this, the control unit 200 may set corrected control parameters so that each axis may finally reach a same work point even though each axis has different initial operation conditions or motion timing, and such parameter correction process may be dynamically updated as the control unit 200 continuously monitors and analyzes real-time data, thereby maintaining a synchronization state of an entire system constant.

In one embodiment, in operation 23, the control unit 200 may transmit a control command based on the control parameters to the collaborative robot 100 and the additional axis device 300. For example, the control unit 200 may generate and transmit a control command suitable for components of each joint portion 110 and the additional axis device 300 based on the calculated control parameters.

The control unit 200 may transmit command data related to position information, speed, acceleration, and torque to each joint portion 110 through an integrated network or a dedicated communication bus, and may simultaneously transmit control commands to a lift 310, a rail 320, and a positioner 330 belonging to the additional axis device 300 according to the same principle.

In this case, the control command includes correction values for minimizing a difference between an operation target value and a current state of each axis, and through this, a driving unit 180 composed of a servo motor and a reducer may be driven precisely within a fine error range. The control unit 200 may repeatedly transmit commands while maintaining a short control cycle of 1 millisecond or less, thereby immediately applying correction commands to minute errors or disturbances occurring in real time, and accordingly, a synchronization state of the entire system may always be maintained in an optimal state.

In one embodiment, in operation 24, the collaborative robot 100 and the additional axis device 300 may be driven in real time in synchronization. For example, the collaborative robot 100 and the additional axis device 300 may be driven simultaneously in real time according to a synchronization control command received from the control unit 200.

Each joint portion 110 of the collaborative robot 100 may move precisely according to a path and control parameters set by the control unit 200, and the gripper 140 may approach the work object 1 through the robot arm 120 to perform a required operation. At the same time, the lift 310 belonging to the additional axis device 300 may support the collaborative robot 100 to perform a stable operation at a high position or a low position by adjusting a vertical position of the collaborative robot 100, and the rail 320 may move the collaborative robot 100 left and right or forward and backward to maximize work efficiency in a wide work area.

In addition, the positioner 330 may provide an optimal work environment in a complex assembly, inspection, or processing process by changing a posture of the work object 1 in a manner of rotating or tilting the work object 1. The control unit 200 may precisely coordinate operation timing of each component as described above, thereby detecting and correcting an unexpected error or disturbance that may occur during work in real time, and accordingly, the collaborative robot 100 and the additional axis device 300 may stably perform a high-speed and high-precision operation in a perfectly synchronized state. Such synchronization control may be particularly useful in maintaining a relative position between the robot arm 120 and the work object 1 constant during process execution, or in a complex process in which operations are performed simultaneously at multiple work points, and may greatly improve productivity and safety of the entire system.

Main components of the present disclosure will be described with reference to FIGS. 3 to 5 as follows.

Referring to FIGS. 3 to 5, a real-time motion synchronization control system 10 according to the present disclosure may perform a complex process by using multi-axis real-time motion synchronization control of the collaborative robot 100, and may include the collaborative robot 100, the control unit 200, and the additional axis device 300.

In one embodiment, as illustrated in FIGS. 3 and 4, the collaborative robot 100 may include the plurality of joint portions 110, the robot arm 120, a base portion 130, the gripper 140, the encoder 150, the current sensor 160, the temperature sensor 170, and the driving unit 180.

For example, the collaborative robot 100 forms a plurality of rotation axes by including the plurality of joint portions 110, and each joint portion 110 is mechanically firmly coupled with the robot arm 120 so that the robot arm 120 may freely move along the plurality of rotation axes. Such a configuration enables the robot arm 120 to secure a high degree of freedom in various work environments, and supports precise access to and manipulation of the work object 1 when performing a complex process. For example, the collaborative robot 100 may be applied to an automobile component assembly process in a production line, and each joint portion 110 may receive position and angle information in real-time through a sensor such as a high-resolution encoder 150 so that the robot arm 120 may implement finely adjusted movement.

In addition, the robot arm 120 may perform linear motion or rotational motion in combination according to a kinematic structure coupled with the joint portion 110, and accordingly, a path for approaching the work object 1 may be optimized in multiple directions. For example, the robot arm 120 may be expanded or contracted simultaneously in horizontal and vertical directions, thereby effectively operating even in a narrow space so that the work object 1 may be stably grasped or released. This function may serve as a core technology that can be utilized in various fields, such as an automated assembly line, a logistics warehouse, or a surgical assistance system in a medical field, in which the robot arm 120 is applied.

Furthermore, the collaborative robot 100 may apply an advanced control algorithm and an integrated sensor network for minimizing motion errors that may occur in a plurality of rotation axes based on continuous and flexible movement of the robot arm 120 installed between the joint portions 110. The control unit 200 may collect such sensor data in real time to correct movement of the robot arm 120 and generate precise control commands so that a relative positional relationship with the work object 1 may be maintained constant. For example, even when the collaborative robot 100 moves at high speed, operations of each joint portion 110 and the robot arm 120 may be consistently maintained so that access to the work object 1 may be stably performed, thereby greatly improving efficiency and safety of an entire process.

In addition, the collaborative robot 100 of the present disclosure is designed to be applicable in various work environments, and may flexibly respond even in a dynamic situation in which the work object 1 moves or a position thereof changes, and may immediately respond to a minute position change or an angle variation of the work object 1 through multi-axis operation of the robot arm 120. For example, the collaborative robot 100 may be applied to a process of assembling electronic components to precisely pick up a very small component and place the component at a specific position, and in this case, rotation and extension operations of the robot arm 120 may be finely adjusted to minimize a gap or an error between components.

In one embodiment, the base portion 130 disposed at a lowermost end of the collaborative robot 100 may be designed to firmly fix an entire robot structure so as to ensure stability of the entire robot against vibration or external impact that may occur in a work environment. The base portion 130 may be made of a rigid material such as a high-strength metal or a composite material, and may perform a support function so as to precisely maintain a position of the robot without fine vibration or shaking caused by external impact even when handling a heavy load or moving at high speed. For example, in an automobile assembly line or an aerospace component production process, the base portion 130 may improve reliability of a production process by ensuring stable posture control even under conditions of heavy materials and high-speed movement.

In one embodiment, the robot arm 120 may be positioned between the plurality of joint portions 110 and may be configured to extend or contract by effectively receiving rotational motion of each joint portion 110, and through this, may play an important role in precisely adjusting a distance to the work object 1 and enabling manipulation at various angles and positions within a work space. The robot arm 120 may be designed to enable fine position adjustment and speed control by incorporating a precision gear mechanism and a high-resolution sensor, and for example, may greatly improve work efficiency and quality by optimizing a path and an angle for approaching the work object 1 in application fields such as electronic component assembly, medical surgery assistance, or precision welding. In addition, the robot arm 120 may support various operation modes through a coupling structure with the joint portions 110, and may stably handle the work object 1 by maintaining precise interlocking among joints even while moving along a complex path.

In one embodiment, the gripper 140 may be installed at an end of the robot arm 120 and may be configured to directly grasp or release the work object 1, and may adopt a multifunctional gripper structure so as to efficiently handle objects of various shapes and sizes. The gripper 140 may employ various driving methods such as a pneumatic type, an electric type, and a hydraulic type, and each driving method may be designed to satisfy both clamping force applied to the work object 1 and precise control. For example, an electric gripper may enable fine adjustment through electronic control, a hydraulic gripper may provide strong pressure so as to be suitable for handling a large component, and a pneumatic gripper may operate advantageously for high-speed work in a production line through a fast response speed. In addition, the gripper 140 may include a replaceable tip or an expansion module so that various clamping methods may be applied according to characteristics of the work object 1, and accordingly, flexibility and efficiency of a production process may be greatly improved.

As described above, the base portion 130, the robot arm 120, and the gripper 140 of the collaborative robot 100 may perform complementary roles so as to support an entire system to accurately and safely process the complex work object 1, and each component may employ an optimized material, kinematic design, and sensor technology in order to ensure stable operation even in a high-speed and high-precision work environment. Such an integrated system may be applied to manufacturing, logistics, medical fields, and various other industrial fields, and may greatly improve work quality and productivity when performing a complex process, and may ensure stability and reliability of an entire process.

In one embodiment, the encoder 150 may be configured as a sensor for precisely measuring a rotation angle or a position of each joint portion 110, and may be configured as a key element that senses a motion state of the collaborative robot 100 in real time and transmits the motion state to the control unit 200. For example, the encoder 150 may support the control unit 200 so that the control unit 200 may finely identify an angle and a position of the robot arm 120 by converting rotational motion of each joint portion 110 into a digital signal. Such measurement data may be utilized as essential input values for setting a work path, synchronization control, PID control, and a real-time correction algorithm, so that precision and reliability of the entire system may be maximized.

In addition, the encoder 150 may be designed to have a high-resolution capability so as to accurately detect even a minute positional change or angular difference, and accordingly, even a minute error among the respective joint portions 110 of the collaborative robot 100 may be detected and corrected in real time. For example, even a minute angular change that occurs when the robot arm 120 rotates at a high speed or approaches the work object 1 may be detected through precise measurement by the encoder 150, and the control unit 200 may immediately calculate a correction command. As described above, the encoder 150 may be implemented in an incremental type or an absolute type, and each type may be selectively applied according to a specific application field or work environment.

Furthermore, the encoder 150 may provide a real-time data stream through communication with the robot arm 120 and each joint portion 110, thereby supporting the control unit 200 to accurately determine a motion state of the entire system and to calculate an optimal control command according thereto. For example, the encoder 150 may be utilized to predict, based on data generated from the sensor, a real-time trajectory of the collaborative robot 100 and to calculate a correction value for synchronization with the additional axis device 300, thereby preventing accumulation of a minute error that may occur during a process.

In addition, the encoder 150 may be installed in combination with a high-precision gear mechanism, and such a structure may be designed to minimize a measurement error caused by an external impact or vibration and to provide stable positional data through a continuous correction process. For example, even when the collaborative robot 100 moves at a high speed, the encoder 150 may transmit accurate positional information of each joint portion 110 in real time, thereby supporting the entire system to operate stably and precisely.

Consequently, the encoder 150 may perform a key role in a control system integrated with the collaborative robot 100 and the additional axis device 300, and may improve precision of work path setting, synchronization control, and a correction algorithm by providing real-time position and angle information, thereby greatly enhancing stability and reliability of the entire system.

In one embodiment, the current sensor 160 may be designed to optimize energy efficiency of the system by monitoring, in real time, a current value consumed when the driving unit 180 drives each joint portion 110. The current sensor 160 may precisely detect a change in an electrical load of a servo motor and a reducer associated with each joint portion 110, thereby providing real-time data to the control unit 200 and allowing the control unit 200 to analyze a power consumption pattern of the entire system.

For example, when the collaborative robot 100 moves at a high speed, the current sensor 160 may detect a sudden rise in current and transmit, in real time, a point at which an overload occurs to the control unit 200, thereby supporting issuance of an immediate safety control command. In addition, the current sensor 160 may employ high-sensitivity sensor technology so as to detect even a minute change in electrical load, and thus may be utilized as data for determining an operating state of the driving unit 180 in detail and for optimizing power consumption and improving energy efficiency. When an abnormal current is generated during operation of the driving unit 180, for example, in a short-circuit or overload situation, the current sensor 160 may rapidly detect the abnormal current and immediately transmit a safety control signal to the control unit 200, thereby ensuring that the entire system may quickly respond to an emergency situation.

As described above, the current sensor 160 may be configured to determine whether the driving unit 180 normally operates through detection of an electrical load and to analyze an energy consumption pattern according to an external environment or a work condition, thereby reducing unnecessary energy loss during a process and enabling optimal operating conditions to be controlled in real time in terms of power management. Consequently, the current sensor 160 may act as a core technology capable of simultaneously maximizing operation reliability of the collaborative robot 100 and the additional axis device 300 and safety operation and energy efficiency of the system.

In one embodiment, the temperature sensor 170 may precisely detect a heat generation state of the driving unit 180 or each joint portion 110, measure temperature data in real time, and transmit the temperature data to the control unit 200, thereby ensuring safe operation of the system and reliability of equipment. The temperature sensor 170 may employ high-sensitivity sensor technology to detect even a minute rise in temperature generated while major components, such as a servo motor or a reducer of the driving unit 180, are operating, and thus may early detect an unexpected overheating situation or an abnormal sign of a component and perform a safety control function such as generating a warning signal to the control unit 200 or automatically stopping an operation.

For example, when a temperature of the driving unit 180 exceeds a preset reference value due to heat generated while the collaborative robot 100 performs a high-load operation or moves at a high speed, the temperature sensor 170 may detect the excessive temperature in real time and transmit abnormal temperature information to the control unit 200 so that the system may be switched to an emergency stop mode or an operating speed may be automatically reduced, thereby preventing damage to equipment.

In addition, the temperature sensor 170 may monitor a heat generation state of each joint portion 110 and may prevent, in advance, mechanical deformation or performance degradation caused by overheating of a driving mechanism or a gear portion embedded in the joint portion 110, thereby supporting maintenance of overall precision and work quality of the collaborative robot 100. Furthermore, the temperature sensor 170 may record measured temperature data so as to analyze a long-term thermal pattern and a change in an operating environment, and thus may be utilized to optimize a maintenance cycle and predict a timing of component replacement.

For example, when the temperature sensor 170 detects a repeated high-temperature state, the control unit 200 may analyze the detected state to identify an aging tendency of a component, issue a warning in advance, or establish an automatic maintenance plan, thereby extending a service life of equipment and preventing an unexpected failure. In addition, the temperature sensor 170 may sensitively react even to a temperature change according to an external environmental change or a work condition and may provide stable data even when a work environment rapidly changes, and such information may play an important role in energy efficiency management and safe operation of the entire system.

Consequently, the temperature sensor 170 may rapidly detect a temperature abnormality generated during operation of the collaborative robot 100 and the additional axis device 300 and may support the control unit 200 in taking an appropriate safety measure based thereon, thereby acting as a key component capable of greatly improving overall safety and reliability of the system.

In one embodiment, the driving unit 180 may include a servo motor, a reducer, and the like in order to precisely drive each joint portion 110 of the collaborative robot 100, and such a configuration may serve to provide power required for allowing each joint portion 110 to stably and precisely move along a motion path required therefor. The driving unit 180 may be designed by integrating advanced electronic control technology and a high-performance motor driver so that a position and an angle of the joint portion 110 may be finely controlled even during a high-speed operation, and accordingly, manipulation accuracy with respect to the work object 1 and productivity of a work process may be greatly improved

For example, the driving unit 180 may process, at a high speed, a minute electrical signal generated when each servo motor individually operates and may control the minute electrical signal in real time in conjunction with the reducer, thereby enabling smooth acceleration and deceleration even during high-speed movement. In addition, the driving unit 180 may be designed to minimize performance degradation due to mechanical wear or heat generation even under long-term continuous operation or a heavy load by employing a high-precision gear mechanism and a highly durable material, and thus reliability and safety of the entire system may be ensured.

Furthermore, the driving unit 180 may be configured to continuously monitor an operating state of each joint portion 110 through real-time communication with the control unit 200 and to immediately perform correction when necessary, which may effectively offset a disturbance or an internal error that may occur during a work process and support the collaborative robot 100 in accurately moving along a predicted path. In addition, the driving unit 180 may employ a control algorithm that optimizes a rotational speed and torque of the servo motor and a gear ratio and efficiency of the reducer so that the entire system may maintain stable and smooth motion performance even in a high-speed operating environment, and such performance improvement may play an important role in a complex palletizing operation or a precise assembly process.

Consequently, the driving unit 180 may act as a key element capable of greatly improving efficiency and safety of the entire process by accurately implementing a motion path required for each joint portion 110 of the collaborative robot 100 and enabling stable and precise position control even under high-speed and high-load conditions through a combination of advanced electronic control technology, a high-performance motor driver, and highly durable mechanical components.

In addition, each component associated with the collaborative robot 100 may operate complementarily to help efficiently handle the work object 1 and to greatly improve overall productivity and stability of the real-time motion synchronization control system. For example, precise position information provided by the encoder 150 may be combined with state information monitored by the current sensor 160 and the temperature sensor 170, thereby contributing to stable driving of each joint portion 110 by the driving unit 180, which may play a decisive role in synchronization and precise control of the entire system.

In one embodiment, as illustrated in FIG. 5, the additional axis device 300 may be coupled to the collaborative robot 100 and may provide, in addition to a plurality of axes corresponding to the plurality of joint portions 110, an additional axis. The additional axis device 300 may include a lift 310 configured to vertically move the collaborative robot 100, a rail 320 configured to horizontally move the collaborative robot 100, and a positioner 330 configured to move the work object 1 of the collaborative robot 100. The additional axis device 300 may support maximization of accessibility to the work object 1 and work precision during performance of a complex process by increasing flexibility of the entire system.

In one embodiment, the lift 310 may perform a role of moving the collaborative robot 100 in a vertical direction within the additional axis device 300. The lift 310 may adjust a height of the collaborative robot 100 so that the robot may perform an operation at a high position or a low position, and may be designed to effectively overcome a height difference between a position at which the work object 1 is disposed and a working range of the robot. For example, the lift 310 may precisely adjust a vertical position of the collaborative robot 100 by using an electric actuator or a hydraulic actuator, thereby assisting the robot in stably performing an operation with respect to a high load or in a complex assembly process. The lift 310 may also communicate with the control unit 200, receive real-time feedback, and perform a minute positional correction according to a synchronized control command, so that a vertical movement operation of the entire system may be maintained within a constant error range.

In one embodiment, the rail 320 may perform a function of moving the collaborative robot 100 in a horizontal direction within the additional axis device 300. The rail 320 may be installed on a fixed structure such as a factory floor or a ceiling so as to support smooth transfer of the collaborative robot 100 in a left-right direction or a front-rear direction, and may allow the robot to move efficiently even when the work object 1 is distributed at multiple positions. The rail 320 may be fabricated in a structure including a linear guide and a precision bearing, thereby minimizing vibration or unnecessary shaking that may occur during movement and improving positional control accuracy of the collaborative robot 100. In addition, the rail 320 may exchange data with the control unit 200 in real time and may allow a positional change of the robot to be made smoothly and stably during a work process through a synchronization command for adjusting a movement speed and an acceleration.

In one embodiment, the positioner 330 may perform a function of rotating or tilting the work object 1 of the collaborative robot 100 within the additional axis device 300. By changing a posture of the work object 1, the positioner 330 may provide an optimal work environment in a complex assembly, inspection, or processing process and may maximize work efficiency by exposing a specific surface or angle of the work object 1. The positioner 330 may include a multi-axis rotation mechanism so that the work object 1 may be rotated or tilted at various angles. In this process, the control unit 200 may support accurate maintenance of a desired posture of the work object 1 by adjusting, in real time, control parameters such as a rotation angle, a speed, and an acceleration. The positioner 330 may also be designed to cope with various forms of the work object 1 by applying a correction factor that may be differently set according to a weight, a size, or a shape of the work object 1.

The additional axis device 300 configured as described above may be coupled to the collaborative robot 100 so as to enable additional operations, such as vertical movement, horizontal movement, and rotation or tilting of the work object 1, which are difficult for the collaborative robot 100 alone to perform, and may greatly expand a working range of the entire system during performance of a complex process. Through communication with the control unit 200, the additional axis device 300 may receive, in real time, operational state information of the collaborative robot 100 and positional information of the work object 1 and, based thereon, may receive control commands such that respective additional components, that is, the lift 310, the rail 320, and the positioner 330, operate in precise synchronization, thereby allowing the entire system to organically operate as one integrated operational system.

In addition, the additional axis device 300 may be designed in a structure capable of greatly improving flexibility and productivity of process execution while expanding an operational range of the collaborative robot 100 and allowing the work object 1 to be handled at various angles and positions. The additional axis device 300 may enable each of the lift 310, the rail 320, and the positioner 330 to operate through an individually optimized control module, thereby overcoming an operational limitation of the conventional collaborative robot 100 alone and supporting efficient performance of high-speed, high-precision work required in various industrial fields, such as complex assembly, inspection, processing, and palletizing processes.

The additional axis device 300 of the present disclosure may employ, in addition to the lift 310, the rail 320, and the positioner 330, various types of additional axes, which may be flexibly changed according to characteristics of a work process and site requirements. For example, the additional axis device 300 may include a telescopic arm so as to further improve accessibility to the work object while expanding a working range of the collaborative robot 100 in horizontal and vertical directions. In addition, by applying a rotary module, the additional axis device 300 may further rotate the work object to precisely adjust an angle thereof, thereby coping with a complex assembly process or a precision inspection operation.

Furthermore, the additional axis device 300 may include a modular additional axis, such as an interchangeable gripper or a multi-tool attachment, so that various work tools may be rapidly replaced and multiple processes may be performed within one system. In addition, by integrating a vision sensor module, a LiDAR sensor, or the like into the additional axis device 300, a function of recognizing a surrounding environment in real time and more precisely determining a position or a shape of the work object so as to reflect the same in synchronization control may be added.

In addition, an additional axis specialized for a specific process, such as an automatic tool changer or a spraying device, may be introduced, thereby further increasing efficiency of process automation. As described above, the additional axis device 300 may be configured to broaden an application range of the real-time motion synchronization control system and to provide an optimal work environment according to requirements of each process by including various additional axes in addition to the lift 310, the rail 320, and the positioner 330.

In one embodiment, the control unit 200 may control each axis such that the plurality of axes and the additional axis are synchronized in real time. For example, as a core component for integrally controlling the collaborative robot 100 and the additional axis device 300 as a single system, the control unit 200 may control each axis such that the plurality of joint portions 110 and the additional axes, such as the lift 310, the rail 320, and the positioner 330, are synchronized in real time to perform an operation. The control unit 200 may include a high-speed processor and may continuously update control commands for the respective axes at a short cycle of 1 ms or less so that all axes may form a simultaneously synchronized path. Such a control method may be configured to detect, in real time, a difference between a current operation state and a target operation state of each axis and, when the difference occurs, immediately transmit a correction command, thereby extremely reducing a synchronization error of the entire system.

In addition, the control unit 200 may precisely collect trajectory information generated from the plurality of joint portions 110 of the collaborative robot 100 and may simultaneously analyze, in real time, operation states of the lift 310, the rail 320, and the positioner 330 of the additional axis device 300. Through this, the control unit 200 may plan a work sequence of the entire process in advance and may calculate control parameters, such as a target position, a speed, an acceleration, and a deceleration, for each axis so as to distribute control commands such that all axes organically cooperate to move. In this process, an integrated control algorithm considering not only individual operations of the respective axes but also interconnectivity of the entire system may be applied, thereby allowing rapid response to an unexpected error or disturbance that may occur during the process.

The control unit 200 may also perform a role of continuously monitoring and correcting a synchronization state based on sensor data received from each joint portion 110 and the additional axis device 300 through a real-time feedback loop. For example, by comprehensively analyzing position data obtained from the encoder 150 and various sensor information, such as information from the current sensor 160 and the temperature sensor 170, the control unit 200 may apply various control techniques, such as PID control, so as to minimize a difference between a command transmitted to the driving unit 180 and an actual operation. As described above, the control unit 200 may efficiently manage, in real time, control commands for the plurality of axes and maintain the entire system in a stable and precise operating state, which may provide an effect of significantly improving work efficiency and quality during performance of a complex process.

As illustrated in FIG. 4, the collaborative robot 100 may cover various work spaces because the plurality of joint portions 110 and the robot arm 120 are connected in an axial direction, and the base portion 130 may be coupled to the ground or a fixing device so as to support the robot arm 120 to move without shaking. The gripper 140 may perform a role of grasping and releasing the work object 1, and the encoder 150, the current sensor 160, and the temperature sensor 170 may measure an operating state of the collaborative robot 100 and may transmit the measured operating state to the control unit 200. The driving unit 180 may include a servo motor and a reducer so as to support each joint portion 110 in accurately implementing a required motion.

As illustrated in FIG. 5, the additional axis device 300 may include the lift 310, the rail 320, the positioner 330, and the like, each of which may actively change an installation position of the collaborative robot 100 or a posture of the work object 1. The lift 310 may adjust a height of the collaborative robot 100 to help the collaborative robot 100 perform an operation even at a position difficult for the plurality of joint portions 110 to access, and the rail 320 may move the collaborative robot 100 left and right so as to cover a wide work area, thereby allowing automated work to be performed at multiple points in a factory. The positioner 330 may rotate or tilt the work object 1 at a predetermined angle, thereby facilitating processes such as welding, coating, and inspection.

Ultimately, the control unit 200 may perform synchronization control of all axes of the collaborative robot 100 and the additional axis device 300 so that a complex process for the work object 1 may be accurately and rapidly performed. In particular, even when the plurality of joint portions 110 rotate at different angles and the lift 310, the rail 320, and the positioner 330 simultaneously operate, the control unit 200 may perform correction so as to minimize an error based on a target position and real-time feedback of each axis. Such synchronization control may provide a great advantage in reducing process time, improving work precision, and ensuring stability of the entire system.

Detailed computational operations of the present disclosure will now be described with reference to FIG. 2.

Referring to FIG. 2, in one embodiment, in operation 31, the control unit 200 may set a target position of the additional axis according to Equation 1.

$$Qad ( t ) = a ( \frac{1}{6} {\sum }_{i = 1}^{6} {Q}_{i} ( t ) ) + b \qquad [ Equation 1 ]$$

Here, Qad(t) is the target position of the additional axis, Qi(t) is an actual position of 6 axes of the collaborative robot, a is a scaling constant for an average operation of the basic 6 axes, and b is a position compensation value (offset) of the additional axis.

For example, the control unit 200 may set the target position Qad(t) such that an additional axis, for example, the lift, the rail, or the positioner, operates harmoniously with a main motion trajectory of the collaborative robot 100. For this purpose, the control unit 200 may refer to Equation 1, collect in real time the positions Qi(t) measured at each of the six joint portions 110 of the robot, and calculate the target position of the additional axis by applying the scaling constant a and the position compensation value (offset) b to a result obtained by averaging the position values.

For example, the control unit 200 may continuously monitor a motion trajectory of the joint portions 110, derive an average value of Qi(t), and determine Qad(t) by multiplying the average value by a and then adding the offset b. Here, a is a coefficient indicating a ratio at which the additional axis should operate relative to an average operation range of the robot, and b may be applied when fine adjustment is required according to a field environment or a process characteristic. Such setting may prevent occurrence of an unnecessary gap between an operation path of the collaborative robot 100 and an operation path of the additional axis device 300, thereby preventing occurrence of a problem such as a collision or overshoot during performance of a complex process.

In addition, the control unit 200 may periodically recalculate Qad(t) by reflecting, at each moment, updated positional information of the robot joint portions 110, thereby controlling the additional axis to respond in real time to movement of the collaborative robot 100.

For example, even when the robot joint portions 110 move at a speed faster than expected or a positional deviation occurs due to an external factor, the control unit 200 may immediately recognize an error between Qad(t) calculated through Equation 1 and the actual position Qa(t) of the additional axis and may issue a correction command through various algorithms such as PID control. Through this, the additional axis may maintain synchronized movement within a constant error range without excessively preceding or lagging behind a main trajectory of the robot, and ultimately an accurate and stable work environment may be implemented even in a complex process. Furthermore, since the scaling constant a and the offset b may be differently set according to a shape or weight of the work object 1 and a process characteristic, the control unit 200 may flexibly cope with various industrial sites by defining the values in advance or adjusting the values in real time.

Ultimately, in operation 31, the process of the control unit 200 setting the target position of the additional axis using Equation 1 may play an important role in lowering a collision risk among a plurality of axes and maximizing process efficiency by precisely controlling the additional axis based on an average operation formed by the six joint portions 110 of the collaborative robot 100.

In one embodiment, in operation 32, the control unit 200 may calculate a control input function U(t) of the additional axis according to Equation 2 based on a proportional integral derivative (PID) control method.

$$U ( t ) = KpE ( t ) + Ki {\int }_{0}^{t} E ( τ ) d τ + Kd \frac{dE ( t )}{dt} , E ( t ) = Qad ( t ) - Qa ( t ) \qquad [ Equation 2 ]$$

Here, E(t) is a control error, Qad(t) is the target position of the additional axis, Qa(t) is an actual position of the additional axis, Kp is a proportional constant, Ki is an integral constant, and Kd is a derivative constant.

For example, the control unit 200 may calculate, by using the proportional integral derivative (PID) control technique, the control input function U(t) for correcting an operation error of the additional axis, such as the lift, the rail, or the positioner, in real time. In this case, the control unit 200 may refer to Equation 2, define a difference between the target position Qad(t) and the actual position Qa(t) of the additional axis as E(t), and then calculate an optimal control command by combining three elements, that is, proportional, integral, and derivative elements. First, the proportional element Kp×E(t) may determine a control signal in proportion to a magnitude of an error occurring at a current time point, thereby compensating the system such that the system immediately corresponds to the target position. For example, the larger the error, the greater the proportional element acts to perform rapid correction, and the smaller the error, the more finely the proportional element acts, thereby inducing stable control.

The integral element Ki×∫E(τ)dτ may serve as a term for offsetting an error accumulated over time and may perform a role of gradually correcting the additional axis when the additional axis continuously exhibits a constant deviation. For example, when the additional axis continuously remains slightly behind the target position, the integral element may reflect the accumulated error and gradually increase a compensation command, thereby preventing long-term accumulation of the error. This may support the system in ultimately converging on the target position even when an external interference or a load change occurs in a process environment and may contribute to improving process stability.

The derivative element Kd×dE(t)/dt may perform predictive compensation for a sudden motion change based on an error variation rate. For example, when the additional axis moves at a high speed or the joint portions 110 suddenly change direction, the derivative element may apply a compensation signal before the error sharply changes, thereby mitigating a phenomenon in which the system excessively shakes or overshoots. This may be advantageous in reducing unnecessary vibration or a collision risk and ensuring stable operation when the robot and the additional axis move in a complex manner during a process.

The PID control configured as described above may operate as a real-time algorithm inside the control unit 200, and may recalculate the difference E(t) between Qad(t) and Qa(t) at each cycle and may update U(t) by recalculating proportional, integral, and derivative elements according to the recalculated difference. Through this, the control unit 200 may transmit an appropriate control command to the driving unit 180 composed of the servo motor and the reducer and may allow the additional axis to maintain a state accurately synchronized with the main trajectory of the collaborative robot 100. For example, in a process in which the robot arm 120 moves at a high speed and the additional axis should accurately adjust a position according to the movement, the PID control may correct a control signal before the error excessively increases and may reduce a deviation accumulated in the long term, thereby supporting stable work.

Ultimately, the PID control performed in operation 32 may provide an advantage in that the additional axis may promptly reach the target position Qad(t) and, at the same time, may immediately respond to an error or disturbance that may occur during a process. By implementing an immediate response through the proportional element, removing an accumulated error through the integral element, and performing a predictive response to a sudden change through the derivative element, synchronization between the additional axis and the collaborative robot 100 may be precisely maintained. This may improve stability and work efficiency of the overall real-time motion synchronization control system and may establish a basis for implementing a more precise and safer robot automation process in various industrial environments.

In one embodiment, in operation 33, the control unit 200 may adjust a synchronization error value represented by Equation 3 to be within 0.1 mm such that the plurality of axes and the additional axis are synchronized in real time.

$$\vert Qa ( t ) - ( a ( \frac{1}{6} {\sum }_{i = 1}^{6} {Q}_{i} ( t ) ) + b ) \vert \qquad [ Equation 3 ]$$

Here, Qa(t) is the actual position of the additional axis, Qi(t) is the actual position of the 6 axes of the collaborative robot, a is the scaling constant for the average operation of the basic 6 axes, and b is the position compensation value (offset) of the additional axis.

For example, Equation 3 represents, as an absolute value, a difference between the actual position Qa(t) of the additional axis, such as the lift 310, the rail 320, or the positioner 330, and the target position Qad(t) calculated by Equation 1, and the control unit 200 may monitor and correct the difference at each control cycle such that the difference is 0.1 mm or less.

For this purpose, the control unit 200 may first calculate the target position Qad(t) of the additional axis based on positional data measured at the joint portions 110 and then define a difference from the actual position Qa(t) of the additional axis as a synchronization error. When the synchronization error exceeds 0.1 mm, the control unit 200 may immediately reduce the error by readjusting PID control parameters Kp, Ki, and Kd or by finely changing values of the scaling constant a and the offset b. For example, when a movement speed of the lift 310 or the rail 320 is excessively high, the control unit 200 may limit an acceleration or a speed so that the additional axis does not excessively precede a main motion trajectory of the robot, and, on the other hand, when the additional axis moves slowly and fails to follow the robot, the control unit 200 may correct the additional axis to recover a relative position by increasing an operation speed or an acceleration.

Such a real time correction process may be particularly useful in a complex palletizing operation or a multi-position process and may have a great effect when the additional axis should be precisely interlocked with an operation of the collaborative robot 100. For example, in a situation in which the positioner 330 should rotate or tilt the work object 1 and the robot arm 120 rapidly operates along a movement path, product quality may deteriorate or a collision risk may occur due to a minute timing difference of the positioner 330. In this case, the control unit 200 may periodically measure the synchronization error and may adjust the PID control parameters in real time so that the error does not exceed 0.1 mm, thereby stably maintaining a relative position between the robot and the additional axis.

Furthermore, the control unit 200 may perform operation correction in consideration of a load state or an external interference by comprehensively analyzing feedback signals collected from sensors, such as the encoder, the current sensor, and the temperature sensor, which are distributed in the joint portions 110 of the collaborative robot 100 and the additional axis device 300. For example, when the additional axis transports a heavy work object or the collaborative robot 100 should move in a narrow space, the control unit 200 may finely adjust an acceleration and a deceleration so that operation timing of the robot and the additional axis is uniformly matched. Through this, work quality and process safety may be improved, and a situation in which large-scale correction should be repeatedly performed due to accumulation of an error may be prevented.

Ultimately, by adjusting the synchronization error to be maintained at 0.1 mm or less according to Equation 3 in operation 33, the control unit 200 may minimize a minute error or inconsistency that may occur when the collaborative robot 100 and the additional axis device 300 perform a complex process. This may contribute to simultaneously improving process efficiency, work safety, and product quality and may support stable operation of an automation system linking the robot and the additional axis in various industrial sites.

In one embodiment, in operation 34, the control unit 200 may transmit a control command to the collaborative robot 100 and the additional axis device 300.

For example, the control unit 200 may generate a command including specific control data, such as a final target position, a target speed, an acceleration, and a torque value of each axis, and may transmit the command to the driving unit 180 composed of a servo motor, a reducer, and the like so that the robot arm 120 and additional axes, such as the lift 310, the rail 320, and the positioner 330, are precisely driven.

The control unit 200 may repeatedly perform such transmission of the control command at a very short cycle and may be designed to receive, in real time, a current operation state of each axis from sensors, such as the encoder, the current sensor, and the temperature sensor, at each control cycle and to correct the command based thereon. In this process, when each axis deviates from a target position due to an unexpected external interference or an internal error, the control unit 200 may immediately detect the error, recalculate and transmit a correction command, and thereby prevent accumulation of the error.

In addition, the control unit 200 may simultaneously transmit control commands for all axes by using an integrated network or a dedicated communication bus, and thereby may support operations of the collaborative robot 100 and the additional axis device 300 to be performed at a high speed in a synchronized state. For example, the control unit 200 may command the robot arm 120 to approach the work object while, at the same time, the lift 310 performs vertical positioning, the rail 320 performs horizontal positioning, and the positioner 330 performs rotation or tilting of the work object, and, because all axes perform such operations in precise synchronization, work quality and safety of the entire system may be greatly improved.

Furthermore, the control unit 200 may set an update cycle of the control command transmitted to each axis to 1 millisecond or less so as to rapidly perform correction of an error according to real-time feedback, and thereby may minimize a relative positional error between the collaborative robot 100 and the additional axis device 300. Such a repetitive control and correction process may immediately respond to a minute disturbance or mechanical error that may occur during process execution, and thus may maintain synchronization of the axes constant even during long-term operation and, consequently, may greatly improve stability and reliability of the entire system.

In addition, the control unit 200 may precisely adjust drive characteristics of the servo motor and the reducer based on control parameters, such as a target position, a speed, an acceleration, and a torque, for each axis, thereby ensuring that an operation of each axis corresponds to a predicted trajectory. Such transmission and correction of the control command may allow all axes in the system to communicate with each other in real time and to be continuously corrected based on sensor feedback, thereby preventing accumulation of an error occurring during the process and maintaining stable operation even in high-speed and high-precision work.

Ultimately, in operation 34, the process of the control unit 200 transmitting the control command to the collaborative robot 100 and the additional axis device 300 may provide an effect capable of maximizing process safety and product quality by allowing the entire system to continuously maintain a predicted work path and a synchronized state and by correcting, in real time, a synchronization problem that may occur due to an external interference or an internal error.

Summarizing the processes from operation 21 to operation 34 described in the above embodiment, the present disclosure may provide an innovative control system in which the basic 6-axis operation of the collaborative robot 100 and the lift 310, the rail 320, and the positioner 330 of the additional axis device 300 are synchronized in real time so that a complex process may be stably and precisely performed.

Based on real-time feedback data collected from sensors, such as the encoder 150, the current sensor 160, and the temperature sensor 170, the control unit 200 may dynamically update the target position Qad(t) of the additional axis, which is calculated by averaging positional information of the joint portions 110, by applying the scaling constant a and the position compensation value b. In addition, the control unit 200 may analyze an error E(t) between the actual position Qa(t) of the additional axis and the target position Qad(t) in three components, that is, proportional, integral, and derivative components, by using the PID control technique, and may calculate the control input function U(t) for correcting the error, thereby ensuring, in real time, a precise synchronization state in which the error is maintained at 0.1 mm or less.

Meanwhile, the control unit 200 may transmit, to the collaborative robot 100 and the additional axis device 300, control commands for each axis, such as a final target position, a target speed, an acceleration, and a torque value, at a short control cycle of 1 ms or less, and, accordingly, may immediately correct an accumulated error caused by an unexpected disturbance or an internal error even during high-speed motion. Such an integrated control system may provide a technical effect of greatly improving work quality, productivity, and process safety in various industrial processes, such as a complex palletizing operation or a multi-position process, while securing stability and reliability of the entire system.

Meanwhile, the disclosed embodiments may be implemented in the form of a recording medium storing instructions executable by a computer. The instructions may be stored in the form of program code and, when executed by a processor, may generate program modules to perform operations of the disclosed embodiments. The recording medium may be implemented as a computer-readable recording medium.

The computer-readable recording medium may include all types of recording media storing instructions that may be interpreted by a computer. Examples thereof may include a ROM (Read Only Memory), a RAM (Random Access Memory), a magnetic tape, a magnetic disk, a flash memory, and an optical data storage device.

As described above, the disclosed embodiments have been described with reference to the accompanying drawings. Those skilled in the art to which the present disclosure pertains will understand that the present disclosure may be practiced in forms different from the disclosed embodiments without changing the technical spirit or essential features of the present disclosure.

The disclosed embodiments are illustrative and should not be construed as limiting.

### REFERENCE SIGNS LIST

10 real-time motion synchronization control system
100 collaborative robot
110 joint portion
120 robot arm
130 base portion
140 gripper
150 encoder
160 current sensor
170 temperature sensor
180 driving unit
200 control unit
300 additional axis device
310 lift
320 rail
330 positioner

What is claimed is:

1. A real-time motion synchronization control method based on multi-axis expansion of a collaborative robot, performed by a collaborative robot system, in which the collaborative robot system includes a collaborative robot including a plurality of joint portions, an additional axis device coupled to the collaborative robot and providing a plurality of axes corresponding to the plurality of joint portions and an additional axis, and a control unit, the method comprising:
controlling, by the control unit, each axis such that the plurality of axes and the additional axis are synchronized in real time.

2. The method of claim 1, further comprising: by the control unit,
setting a work path of the collaborative robot;
setting control parameters of the plurality of joint portions and the additional axis device such that the plurality of joint portions and the additional axis device are synchronized in real time; and
transmitting a control command based on the control parameters to the collaborative robot and the additional axis device.

3. The method of claim 2, wherein the control parameters include at least one of a position, a rotation angle, a movement distance, a torque, a speed, an acceleration, and a deceleration.

4. The method of claim 3, further comprising: by the control unit,
setting a target position of the additional axis according to Equation 1.
$$Qad ( t ) = a ( \frac{1}{6} {\sum }_{i = 1}^{6} {Q}_{i} ( t ) ) + b \qquad [ Equation 1 ]$$
Here, Qad(t) is the target position of the additional axis, Qi(t) is an actual position of 6 axes of a collaborative robot, a is a scaling constant for an average operation of a basic 6 axes, and b is a position compensation value (offset) of the additional axis.

5. The method of claim 4, further comprising: by the control unit,
calculating a control input function U(t) of the additional axis according to Equation 2 based on a proportional integral derivative (PID) control method.
$$U ( t ) = KpE ( t ) + Ki {\int }_{0}^{t} E ( τ ) d τ + Kd \frac{dE ( t )}{dt} , E ( t ) = Qad ( t ) - Qa ( t ) \qquad [ Equation 2 ]$$
Here, E(t) is a control error, Qad(t) is the target position of the additional axis, Qa(t) is an actual position of the additional axis, Kp is a proportional constant, Ki is an integral constant, and Kd is a derivative constant.

6. The method of claim 5, further comprising: by the control unit,
adjusting a synchronization error value represented by Equation 3 to be within 0.1 mm such that the plurality of axes and the additional axis are synchronized in real time.
$$\vert Qa ( t ) - ( a ( \frac{1}{6} {\sum }_{i = 1}^{6} {Q}_{i} ( t ) ) + b ) \vert \qquad [ Equation 3 ]$$
Here, Qa(t) is the actual position of the additional axis, Qi(t) is the actual position of the 6 axes of the collaborative robot, a is the scaling constant for the average operation of the basic 6 axes, and b is the position compensation value offset of the additional axis.

7. The method of claim 6, wherein the additional axis device includes a lift configured to vertically move the collaborative robot.

8. The method of claim 7, wherein the additional axis device includes a rail configured to horizontally move the collaborative robot.

9. The method of claim 8, wherein the additional axis device includes a positioner configured to move a work object of the collaborative robot.

10. A real-time motion synchronization control system based on multi-axis expansion of a collaborative robot, comprising:
a collaborative robot including a plurality of joint portions;
an additional axis device coupled to the collaborative robot and providing a plurality of axes corresponding to the plurality of joint portions and an additional axis; and
a control unit configured to control each axis such that the plurality of axes and the additional axis are synchronized in real time.
